(19) United States
(12) Patent Application Publication
(10) Pub. No.: US 2016/0018290 A1
(43) Pub. Date: Jan. 21, 2016

(54) INTERNAL COMBUSTION ENGINE

(71) Applicant: GE Jenbacher GmbH & Co OG, Jenbach (AT)

(72) Inventor: Friedhelm HILLEN, Jenbach (AT)

(21) Appl. No.: 14/795,192

(22) Filed: Jul. 9, 2015

(30) Foreign Application Priority Data
Jul. 21, 2014 (AT) 573/2014

(51) Int. Cl. G01M 15/10

(52) U.S. Cl. CPC G01M 15/102

(57) ABSTRACT

An internal combustion engine includes at least one cylinder, at least one feed conduit for combustion gas, and at least one exhaust gas conduit for carrying exhaust gas away from the internal combustion engine. A measuring device determines the gas quality of a combustion gas which can be fed to the internal combustion engine by the feed conduit. The measuring device includes at least one catalyst unit to which exhaust gas from the internal combustion engine can be fed, and at least one sensor downstream of the catalyst unit for detecting a parameter which is characteristic of the conversion rate of the catalyst unit. The gas quality of the combustion gas fed to the internal combustion engine can be determined by the measuring device for determining the gas quality depending on the parameter which is ascertained by the sensor.

The invention concerns an internal combustion engine having the features of the preamble of claim 1 and a method of operating such an internal combustion engine having the features of the preamble of claim 6.

An interesting use of gas-operated internal combustion engines (gas engines) involves the use of fermentation or landfill gases which in the past were disposed of without being used, for example by being burnt off. Those gases are frequently of a calorific value which makes them suitable for use in gas engines. A disadvantage with the use of fermentation or landfill gases is their high content of impurities which can damage the gas engine. In particular in that respect mention is to be made of so-called volatile organic silicon compounds (VOSC) which generally originate from detergents. Upon combustion in the gas engine silicon oxide is formed from those organic silicon compounds, and that silicon oxide is deposited in the combustion chamber and adjacent components and leads to serious wear problems. Gas engines which are operated with fermentation or landfill gas therefore frequently have an upstream-connected gas purification unit (mostly with activated carbon filters) in which the organic silicon compounds are separated out of the fuel gas. Hydrogen sulfide and other organic impurities as well as particulates can also be removed therewith.

For reliable operation of the internal combustion engine it is desirable for the function of the gas purification unit to be monitored on the basis of the gas quality of the combustion gas which is purified in the gas purification unit.

It will be noted however that online measurement of the gas quality downstream of the above-mentioned gas purification units is very costly and is therefore not viable for most installations. Offline measurements of the gas quality by way of taking gas samples or analysis of lubricating oil in which silicon residues can also be detected need several days for analysis and are therefore also unsuitable for monitoring the action of the filter installation.

In the state of the art therefore the procedure is such that generally there are provided two filter units which are disposed in parallel flow relationship and of which only one respective one has the combustion gas to be purified flowing therethrough. The filter units are alternately regenerated or exchanged so that there is always a “fresh” filter unit available. After fixed intervals the unused filter unit is brought into operation as the working filter and the used filter unit is regenerated.

In that respect the intervals for regeneration of the filter units are selected to be conservative so that silicon compounds or other harmful organic compounds are substantially prevented from crossing over into the internal combustion engine. Conservative means that the intervals for regeneration are selected to be short, even if that would not be necessary at all on the basis of the currently prevailing occupancy state of the filter unit. That procedure is naturally uneconomical as the filter units are regenerated much more frequently than would be actually necessary. As however no knowledge of the current gas quality downstream of the filter installation is available that is the only safe mode of operation.

The object of the invention is to provide an internal combustion engine having a measuring device for determining the gas quality of a combustion gas which can be fed to the internal combustion engine as well as a method of operating such an internal combustion engine, which avoid the disadvantages of the state of the art.

That object is attained by an internal combustion engine having the features of claim 1 and a method having the features of claim 6. Advantageous embodiments are defined in the appendant claims.

By virtue of the fact that there is provided a measuring device for determining the gas quality of a combustion gas which can be fed to the internal combustion engine by way of the feed conduit, wherein the measuring device includes at least one catalyst unit to which exhaust gas from the internal combustion engine can be fed includes at least one sensor arranged downstream of the catalyst unit for detecting a parameter characteristic of the conversion rate of the catalyst unit, wherein the gas quality of the combustion gas fed to the internal combustion engine can be determined by the measuring device for determining the gas quality in dependence on the parameter which is determined by the sensor and which is characteristic of the conversion rate of the catalyst unit, it can therefore be ascertained whether the gas purification unit disposed upstream of the internal combustion engine is working properly.

The invention makes use of the realization that, when impurities—caused for example by a gas purification unit which is not operating properly in the combustion gas feed to the internal combustion engine—pass into the engine, a catalyst unit arranged in the exhaust gas flow of the internal combustion engine registers that by a drop in the conversion rate. The reason for this is masking of the catalyst surface of the catalyst unit. In the event of organic silicon compounds breaking through, masking by silicon oxide (SiO2) occurs. If hydrogen sulfide (H2S) passes through the gas purification unit the sulfur leads to masking of the catalyst surface of the catalyst unit. A break-through of particulate impurities can also lead to the catalyst surface becoming covered. The proposed arrangement makes it possible to monitor the conversion rate or a change in the conversion rate of the catalyst unit and can thus provide a robust possible option for determining the gas quality.

Sensors which can generate a signal which is indicative of the functioning of the catalyst unit are suitable for monitoring the conversion rate. For example temperature sensors, oxygen sensors or CO sensors can be considered here. It is preferably provided that the sensor is a sensor for determining the CO concentration.

Sensors for detecting a carbon monoxide (CO) concentration are a particularly desirable possible way of monitoring the conversion rate of a catalyst unit. The untreated exhaust gas downstream of the internal combustion engine always has certain amounts of CO which can be oxidized in a catalyst unit. Accordingly the CO concentration downstream of a catalyst unit is a suitable indicator for the functioning thereof. Taking the example of a temperature sensor, the drop in a conversion rate of the catalyst unit would be detected for example by falling temperatures when the catalyst unit converts less CO or unburnt hydrocarbons.

It can preferably be provided that the measuring device includes at least one further sensor for determining the CO concentration upstream of the catalyst unit. With that arrangement it is possible to determine the CO concentration downstream and upstream of the catalyst unit. That permits even more accurate monitoring of the conversion rate of the catalyst unit, than with only one sensor for determining the CO concentration downstream of the catalyst unit. Specified here in relation to the example of the CO sensor the advantage of this arrangement naturally also applies to other sensors as set forth hereinbefore.

The arrangement of the sensors “upstream” and “downstream” of the catalyst unit denotes their position in relation to the exhaust gas flow from the internal combustion engine.

It can preferably be provided that the measuring device is so arranged that only a part of the exhaust gases from the internal combustion engine flows through the measuring device. That embodiment describes the situation whereby only a part of the exhaust gas mass flow from the internal combustion engine is fed to the measuring device. That can be embodied for example by a take-off conduit which is in parallel relationship with the exhaust gas conduit and in which the measuring device is disposed. In that way the measuring device can be of a small and inexpensive configuration.

According to a further preferred embodiment it can be provided that substantially all the exhaust gases from the internal combustion engine flow through the measuring device. That embodiment describes the situation whereby substantially the entire exhaust gas mass flow from the internal combustion engine passes through the catalyst unit of the measuring device. Thus the exhaust gases from the internal combustion engine are catalytically purified by the catalyst unit of the measuring device and the measuring device also serves for exhaust gas post-treatment of the internal combustion engine.

As the method it is provided that a parameter characteristic of the conversion rate of the catalyst unit is measured by means of the at least sensor and the gas quality of the combustion gas is inferred in dependence on the ascertained parameter which is characteristic of the conversion rate of the catalyst unit.

It is preferably provided that the parameter characteristic of the conversion rate of the catalyst unit is the CO concentration.

As stated hereinbefore the penetration of organic compounds, in particular organic silicon compounds, into the internal combustion engine—the penetration is caused for example by a gas purification unit which is not operating properly in the combustion gas feed to the internal combustion engine—causes a drop in the conversion rate of a catalyst unit arranged in the exhaust gas flow from the internal combustion engine. The reason for this is masking of the catalyst surface by the species which have broken through or their combustion products.

Particularly preferably it can be provided that the parameter characteristic of the conversion rate of the catalyst unit is measured upstream and downstream of the catalyst unit and the gas quality of the combustion gas is inferred in dependence on the measured difference.

In a variant of the method the CO concentration is measured upstream and downstream of the catalyst unit and thus the conversion rate is monitored.

The conversion rate of the catalyst unit can be even more precisely detected by measurement of the CO concentration upstream and downstream of the catalyst unit.

The invention is discussed in greater detail hereinafter with reference to the Figures in which:

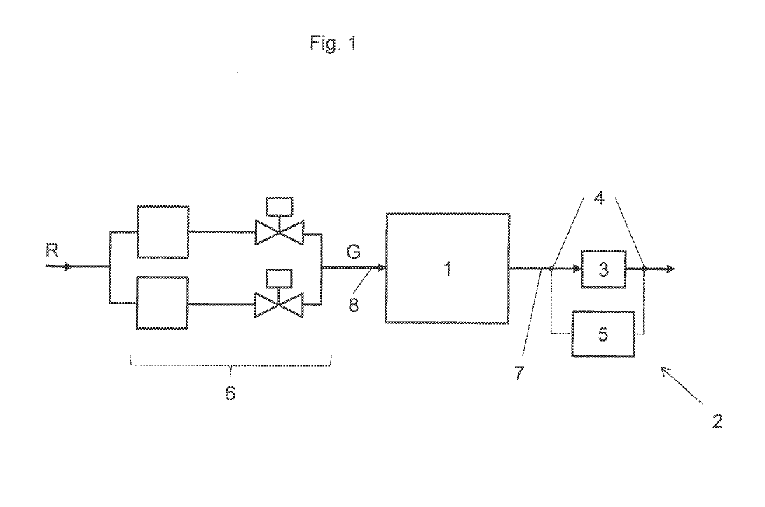

FIG. 1 shows an internal combustion engine having a measuring device for determining the gas quality, and

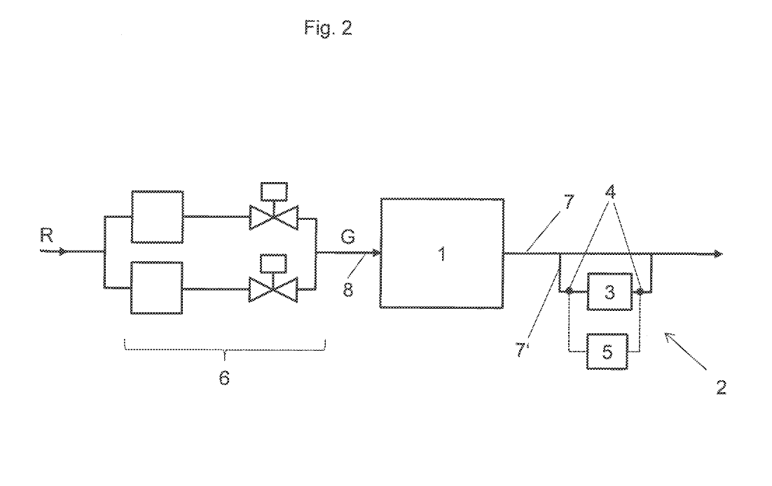

FIG. 2 shows an internal combustion engine according to an alternative embodiment.

Figure shows an arrangement of an internal combustion engine 1 with a measuring device 2 arranged in the exhaust gas conduit 7 of the internal combustion engine 1. The measuring device 2 includes a catalyst unit 3 and at least one sensor 4 for determining the CO concentration in the exhaust gas. Shown in the Figure are a sensor 4 downstream of the catalyst unit 3 and a further—optional—sensor 4 upstream of the catalyst unit 3. The signals from the sensors for detecting the CO concentration in the exhaust gas are fed to a closed-loop/open-loop control unit 5. Fuel gas G is fed to the internal combustion engine 1 by way of the fuel gas line 8. For the sake of completeness the drawing also shows a gas purification unit 6 in which untreated raw gas R is purified before it is fed as combustion gas G to the internal combustion engine 1. The CO concentration of the exhaust gas downstream of the catalyst unit 3 is monitored by way of the sensor 4 downstream of the catalyst 3. In the event of impurities from the raw gas R breaking through into the fuel gas G the sensor 4 detects an increase in the CO concentration in the exhaust gas. The open-loop/closed-loop control device 5 decides on the basis of the signals whether the gas purification unit 6 has to be generated and/or the combustion gas machine 1 has to be shut down. For that purpose the open-loop/closed-loop control device 5 passes commands to the gas purification unit 6 and/or the internal combustion engine 1 (signal lines are not shown). Optionally the CO concentration in the exhaust gas is also monitored with a second sensor 4 upstream of the catalyst unit 3. The conversion rate of the catalyst device 3 can be monitored even more accurately by virtue of that arrangement with sensors 4 upstream and downstream of the catalyst unit 3, than with only one sensor 4 downstream of the catalyst unit 3.

FIG. 2 shows an arrangement as shown in FIG. 1, wherein the measuring device 2 is here disposed in a take-off conduit 7′ arranged in parallel flow relationship with the exhaust gas conduit 7. The advantage of the arrangement shown in FIG. 2 is that only a part of the exhaust gases from the internal combustion engine 1 has to flow through the measuring device 2 and thus the catalyst unit 3 of the measuring device 2 can be smaller and thus less expensive. In regard to the arrangement of the sensors 4 and the connections thereof the foregoing description relating to FIG. 1 applies there.

The description of the Figures is set forth by way of example for a CO sensor but it naturally also applies to other sensors which are referred to in the description of the invention and which can deliver a signal which is indicative of the conversion rate of the catalyst unit 3.

### LIST OF REFERENCES USED

1 internal combustion engine
2 measuring device
3 catalyst unit
4 sensor(s)
5 open-loop/closed-loop control device
6 gas purification device
7 exhaust gas conduit
7′ exhaust gas take-off conduit
8 combustion gas feed conduit
G combustion gas
R raw gas

1. An internal combustion engine including:
at least one cylinder,
at least one feed conduit for combustion gas, and
at least one exhaust gas conduit for carrying exhaust gas away from the internal combustion engine,
wherein there is provided a measuring device for determining the gas quality of a combustion gas which can be fed to the internal combustion engine by way of the feed conduit, wherein the measuring device includes at least one catalyst unit to which exhaust gas from the internal combustion engine can be fed and at least one sensor arranged downstream of the catalyst unit for detecting a parameter which is characteristic of the conversion rate of the catalyst unit, wherein the gas quality of the combustion gas fed to the internal combustion engine can be determined by the measuring device for determining the gas quality in dependence on the parameter which is ascertained by the sensor and which is characteristic of the conversion rate of the catalyst unit.

2. An internal combustion engine as set forth in claim 1, wherein the sensor is a sensor for determining the CO concentration.

3. An internal combustion engine as set forth in claim 1, wherein the measuring device includes at least one further sensor upstream of the catalyst unit.

4. An internal combustion engine as set forth in claim 1, wherein the measuring device is so arranged that only a part of the exhaust gases from the internal combustion engine flows through the measuring device.

5. An internal combustion engine as set forth in claim 1, wherein in that substantially all the exhaust gases from the internal combustion engine flow through the measuring device.

6. A method of operating an internal combustion engine as set forth in claim 1, wherein a parameter characteristic of the conversion rate of the catalyst unit is measured by means of the at least one sensor and the gas quality of the combustion gas is inferred in dependence on the ascertained parameter which is characteristic of the conversion rate of the catalyst unit.

7. A method as set forth in claim 6, wherein the parameter characteristic of the conversion rate of the catalyst unit is the CO concentration.

8. A method as set forth in claim 6, wherein the parameter characteristic of the conversion rate of the catalyst unit is measured upstream and downstream of the catalyst unit and the gas quality of the combustion gas is inferred in dependence on the measured difference.
